(19) United States
(12) Patent Application Publication
(10) Pub. No.: US 2025/0374243 A1
(43) Pub. Date: Dec. 4, 2025

(54) TRANSMISSION LEAKAGE MITIGATION

(71) Applicant: QUALCOMM Incorporated, San Diego, CA (US)

(72) Inventors: Adrianus VAN BEZOOIJEN, Molenhoek (NL); Maurice Adrianus DE JONGH, Nijmegen (NL); Brian GEORGE, San Diego, CA (US); Sheng-Yuan TU, San Diego, CA (US); David Loweth WINSLOW, San Diego, CA (US)

(21) Appl. No.: 19/222,524

(22) Filed: May 29, 2025

Related U.S. Application Data
(60) Provisional application No. 63/654,574, filed on May 31, 2024.

(51) Int. Cl. H04W 72/044

(52) U.S. Cl. CPC H04W 72/044

(57) ABSTRACT

A method, for transmit signal leakage mitigation in an apparatus includes: determining an antenna reflection parameter corresponding to a transmit antenna of the apparatus based on a first portion of a transmit signal and a reflected signal that corresponds to a reflection of a second portion of the transmit signal by the transmit antenna; and implementing, based on the antenna reflection parameter, a selected signal suppression circuit reflection parameter value of a plurality of possible signal suppression circuit reflection parameter values.

### CROSS-REFERENCE TO RELATED APPLICATIONS

This application claims the benefit of U.S. Provisional Application No. 63/654,574, filed May 31, 2024, entitled “TRANSMISSION LEAKAGE MITIGATION,” which is assigned to the assignee hereof, and the entire contents of which are hereby incorporated herein by reference for all purposes.

### BACKGROUND

RFID (Radio Frequency Identification) readers for use with passive RFID tags, and even semi-passive RFID tags, may use high transmit powers in order to provide sufficient power to an RFID tag for the RFID tag to respond with a signal of sufficient strength to be received and decoded by the RFID reader. Due to the high-power transmission, and leakage that may occur between a transmit path and a receive path in the RFID reader, a back-scattered signal from an RFID tag may be overwhelmed and/or a receive path may overloaded by the leakage signal. To combat this effect, some RFID readers (e.g., UHF (Ultra-High Frequency) RFID readers) have used a cancelation circuit to suppress the transmit signal that leaks toward the receive path of the reader.

### SUMMARY

An example apparatus includes: a power amplifier; a transmit antenna; a memory; a signal suppression circuit having a plurality of possible signal suppression circuit reflection parameter values; routing circuitry, communicatively coupled to the power amplifier, the transmit antenna, and the signal suppression circuit; and a processor, communicatively coupled to the memory, the signal suppression circuit, and the routing circuitry, configured to: determine an antenna reflection parameter based on a first portion of a transmit signal from the power amplifier and a reflected signal that corresponds to a reflection, by the transmit antenna, of a second portion of the transmit signal from the power amplifier; and control, based on the antenna reflection parameter, the signal suppression circuit to implement a selected signal suppression circuit reflection parameter value of the plurality of possible signal suppression circuit reflection parameter values.

An example method for transmit signal leakage mitigation in an apparatus includes: determining an antenna reflection parameter corresponding to a transmit antenna of the apparatus based on a first portion of a transmit signal and a reflected signal that corresponds to a reflection, by the transmit antenna, of a second portion of the transmit signal; and implementing, based on the antenna reflection parameter, a selected signal suppression circuit reflection parameter value of a plurality of possible signal suppression circuit reflection parameter values.

Another example apparatus includes: means for determining an antenna reflection parameter corresponding to a transmit antenna of the apparatus based on a first portion of a transmit signal and a reflected signal that corresponds to a reflection, by the transmit antenna, of a second portion of the transmit signal; and means for implementing, based on the antenna reflection parameter, a selected signal suppression circuit reflection parameter value of a plurality of possible signal suppression circuit reflection parameter values.

Another example apparatus includes: a signal source; a power amplifier communicatively coupled to the signal source; a transmit antenna; transmit routing circuitry communicatively coupled to the power amplifier and the transmit antenna, and configured to selectively couple the power amplifier to the transmit antenna; a processor; and a signal suppression circuit communicatively coupled to the processor and comprising a plurality of reactive components at least one of which has a variable reactance selectable by the processor.

### BRIEF DESCRIPTION OF THE DRAWINGS

FIG. 1 is a block diagram of a Radio Frequency Identification (RFID) system.

FIG. 2 is a block diagram of an example of the RFID system shown in FIG. 1.

FIG. 3 is a block diagram of an antenna, a signal suppression circuit, and an example of routing circuitry shown in FIG. 2, showing details of the example of the routing circuitry.

FIG. 4 is a circuit diagram of a double-pi network as an example of the signal suppression circuit shown in FIG. 2.

FIG. 5 is a circuit diagram of another double-pi network as another example of the signal suppression circuit shown in FIG. 2.

FIG. 6 is a table of canceler reflection coefficients and signal suppression circuit component impedance settings.

FIG. 7 is a block diagram of an antenna, a signal suppression circuit, and another example of routing circuitry shown in FIG. 2, showing details of the example of the routing circuitry.

FIG. 8 is a block diagram of another example of the RFID system shown in FIG. 1, including an antenna tuner in an RFID reader.

FIG. 9 is a block flow diagram of a method of suppressing transmit signal leakage in an RFID reader.

FIG. 10 is a block flow diagram of another method of suppressing transmit signal leakage in an RFID reader.

FIG. 11A is a block diagram of FIG. 3 with switches of the routing circuitry positioned to implement mode A of the routing circuitry.

FIG. 11B is a block diagram of FIG. 3 with switches of the routing circuitry positioned to implement mode B of the routing circuitry.

FIG. 11C is a block diagram of FIG. 3 with switches of the routing circuitry positioned to implement mode C of the routing circuitry.

FIG. 11D is a block diagram of FIG. 3 with switches of the routing circuitry positioned to implement mode D of the routing circuitry.

FIG. 11E is a block diagram of FIG. 3 with switches of the routing circuitry positioned to implement mode E of the routing circuitry.

FIG. 11F is a block diagram of FIG. 3 with switches of the routing circuitry positioned to implement mode F of the routing circuitry.

FIG. 11G is a block diagram of FIG. 3 with switches of the routing circuitry positioned to implement mode G of the routing circuitry.

### DETAILED DESCRIPTION

Techniques are discussed herein for mitigating transmit signal leakage from a transmit path of an apparatus into a receive path of the apparatus. For example, routing circuitry that includes one or more couplers and multiple switches may selectively couple a transmit path (e.g., a power amplifier of the transmit path) to an antenna, or to a signal suppression circuit (which may be called a canceler), to a load, or to a processor. The routing circuitry may also selectively couple the antenna to a load or to the processor. The signal suppression circuit may provide different reflection coefficients (e.g., based on multiple impedance settings of the signal suppression circuit). The processor may control the signal suppression circuit and the routing circuitry to provide a signal to the processor for each impedance setting, and thus each reflection coefficient, of the signal suppression circuit. The processor may control the routing circuitry to selectively provide signals to the processor that the processor may use to determine the reflection coefficients of the signal suppression circuit, to determine a reference reflection coefficient, and to determine a reflection coefficient of the antenna relative to the transmit path. The reflection coefficient of the antenna may vary with changing conditions (e.g., environmental conditions presented to the antenna), and the processor may determine and select an impedance of the signal suppression circuit to cause destructive interference between a portion of a transmit signal reflected by the signal suppression circuit and a leakage portion of the transmit signal that leaks into the receive path of the apparatus. The destructive interference may help an RFID reader (Radio Frequency Identification reader) receive and decode an ID from an RFID tag, e.g., by helping mitigate a leakage portion of a transmit signal due to routing circuitry, antenna port reflection, and/or other parasitic coupling. A double-pi arrangement may be used for the signal suppression circuit. An impedance tuner may be used to attempt to reduce mismatch between the transmit path and the antenna. Once an impedance of the signal suppression circuit is selected, other similar impedances of the signal suppression circuit may be tried to determine whether better leakage signal mitigation is achieved. The discussion herein focuses on examples where the apparatus is an RFID reader, but the discussion is applicable to other devices. The configurations and implementations discussed above are examples, and other examples may be implemented.

Items and/or techniques described herein may provide one or more of the following capabilities, as well as other capabilities not mentioned. Transmit signal leakage in an RFID reader may be reduced. A frequency range over which transmit signal leakage is reduced in an RFID reader may be increased. Transmit signal leakage mitigation in an RFID reader may be fine tuned. RFID reader usable range/distance may be increased, e.g., due to better receive signal reception/decoding due to less transmit signal leakage effects. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

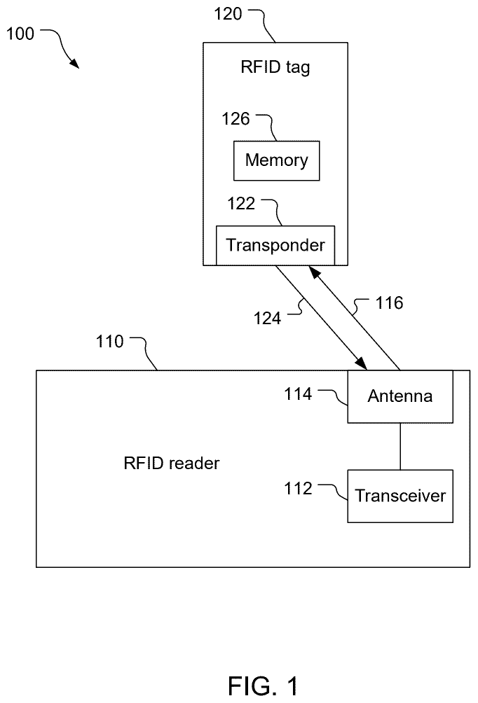

Referring to FIG. 1, an RFID system 100 (Radio Frequency Identification system) includes an RFID reader 110 and an RFID tag 120. The RFID reader 110, also called an interrogator, includes a transceiver 112 and an antenna 114. The RFID reader 110 is configured to emit an RF signal 116 from the transceiver 112 via the antenna 114. The signal 116 is received by the RFID tag 120 and provides power to a transponder 122 (that includes an antenna (not shown)) of the tag 120, with the tag 120 being a passive or semi-passive RFID tag. The transponder 122 transmits a signal 124 in response to receiving the signal 116, with the signal 124 including information stored by the tag 120, e.g., in memory 126, such as a unique identifier of the tag 120. The RFID reader 110 receives the signal 124 into the transceiver 112 via the antenna 114. The RFID reader 110 may process the information received from the tag 120, e.g., providing some or all of the received information via the transceiver 112 (and possibly the antenna 114) to a host device, e.g., for further processing. Some of the signal 116 may leak (before being emitted from the antenna 114) into a receive path of the RFID reader 110.

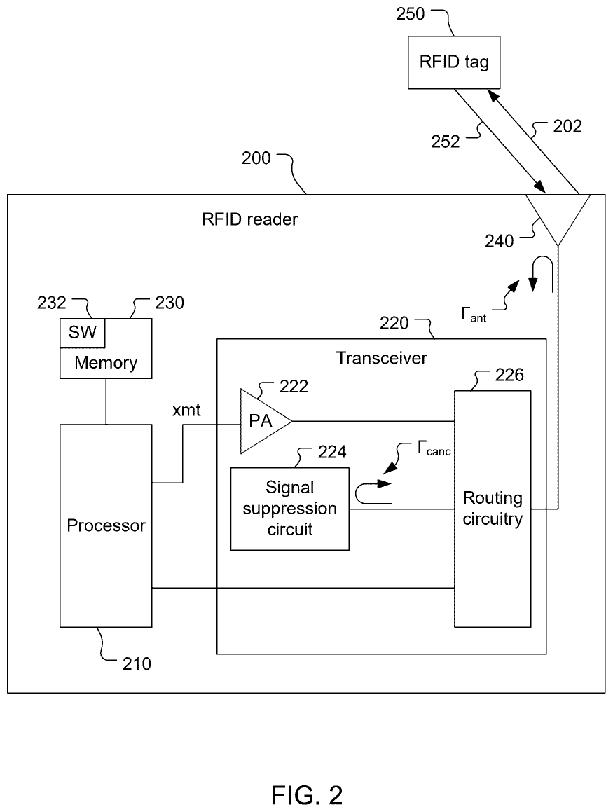

Referring also to FIG. 2, an example of the system shown in FIG. 1 includes an RFID reader 200 and an RFID tag 250. The RFID reader 200 (which may be called a reader) includes a processor 210, a transceiver 220, a memory 230, and an antenna 240, and may be configured to mitigate leakage of a transmit signal from a transmit path of the reader 200 into a receive path of the reader 200, as discussed more fully below. The transmit path connects the PA 222 through the routing circuitry 226 to the antenna 240 and the receive path connects the antenna 240 through the routing circuitry 226 to the processor 210. The reader 200 may transmit a wireless signal 202 to the tag 250 and the tag 250 may transmit a wireless signal 252 to the reader 200 in response to receiving the wireless signal 202.

The processor 210, the transceiver, the memory 230, and the antenna 240 may be communicatively coupled to each other by one or more buses or other transmission lines (which may be configured, e.g., for optical and/or electrical communication). Even if referred to in the singular, the processor 210 may include one or more processors, the transceiver 220 may include one or more transceivers (e.g., one or more transmitters and/or one or more receivers), the memory 230 may include one or more memories, and the antenna 240 may include one or more antennas. The processor 210 may include one or more hardware devices, e.g., a central processing unit (CPU), a microcontroller, an application specific integrated circuit (ASIC), etc.

The description herein may refer to the processor 210 performing a function, but this includes other implementations such as where the processor 210 executes software and/or firmware. The description herein may refer to the reader 200 performing a function as shorthand for one or more appropriate components of the reader 200 performing the function, e.g., hardware, software, firmware, or a combination thereof performing the function.

The memory 230 is a non-transitory storage medium that may include random access memory (RAM), flash memory, disc memory, and/or read-only memory (ROM), etc. The memory 230 may store software 232 which may be processor-readable, processor-executable software code containing instructions that are configured to, when executed, cause the processor 210 to perform various functions described herein. Alternatively, the software 232 may not be directly executable by the processor 210 but may be configured to cause the processor 210, e.g., when compiled and executed, to perform the functions. The processor 210 may include a memory with stored instructions in addition to and/or instead of the memory 230.

The transceiver 220 includes a PA 222 (Power Amplifier), a signal suppression circuit 224 (which may include one or more circuits) and routing circuitry 226 (which may be called a routing circuit and may include one or more circuits). The transceiver 220 is configured to convey transmit signals from the processor 210 to the antenna and to convey receive signals from the antenna 240 to the processor 210, with the antenna 240 being configured to transduce a transmit signal from a guided signal to the wireless signal 202 and to transduce the wireless signal 252 to a guided signal (e.g., electrical and/or optical signal). For example, the PA 222 is configured to amplify a transmit signal (xmt) received from the processor 210 and provide the amplified transmit signal to the routing circuitry 226. The signal suppression circuit 224 is configured to provide a selected impedance to provide a corresponding reflection coefficient Γ_{canc} to use in producing a suppression signal to destructively add with a leakage portion of the transmit signal that leaks from the transmit path to the receive path in the transceiver 220. The routing circuitry 226 is configured to selectively route transmit signals, receive signals, and reflected signals to and/or from the processor 210 and the antenna 240, or to one or more loads, in order to allow the reader 200 to operate normally (to obtain information from the tag 250), and to enable the processor 210 to determine reflection coefficients for different impedance values of the signal suppression circuit 224, to determine a dynamic reflection coefficient Γₐₙₜ of the antenna 240, and to determine a reference reflection coefficient for use in transmit signal leakage mitigation during normal operation. The transceiver 220 may include other components not shown (e.g., a digital-to-analog converter (DAC) as part of a transmit path of the transceiver 220 between the processor 210 and the PA 222, and a low-noise amplifier (LNA) and an analog-to-digital converter (ADC) in a receive path of the transceiver 220) between the routing circuitry 226 and the processor 210.

The processor 210 is configured to determine an indication of transmit signal leakage from a transmit path of the transceiver 220 into a receive path of the transceiver 220 and to control the signal suppression circuit 224 to suppress the transmit signal leakage in the receive path of the transceiver 220. The transmit signal leakage may include energy of a transmit signal reflected by the antenna 240 (including any impedance tuner) in accordance with an antenna reflection coefficient Γₐₙₜ. The antenna reflection coefficient may vary with environment of the reader 200, e.g., proximity and orientation of the antenna 240 to the RFID tag 250, different RFID tags, objects (e.g., a finger of a user) in proximity to the antenna 240, etc. The signal suppression circuit 224 provides a canceler reflection coefficient Γ_{canc} based on an impedance of the signal suppression circuit 224. The processor 210 may control the impedance of the signal suppression circuit 224 to attempt to make the following relationship true

$${Γ}_{ant} + {Γ}_{c a n c} = 0 \qquad ( 1 )$$

Thus, the processor 210 may select an impedance (and thus the canceler reflection coefficient Γ_{canc}) of the signal suppression circuit 224 based on the antenna reflection coefficient Γₐₙₜ. Because the antenna reflection coefficient Γₐₙₜ may vary over time, the processor 210 may determine a desired canceler reflection coefficient Γ_{canc} over time, e.g., intermittently such as periodically, semi-persistently (e.g., periodically once a tag session has begun), asynchronously (e.g., being triggered at start-up of the reader 200, or upon detection of an RFID tag in proximity to the antenna 240 (e.g., upon detection of a change of input impedance to the antenna 240)). Alternatively, the canceler reflection coefficient Γ_{canc} may be determined once, e.g., during manufacture of the reader 200, stored, and not changed.

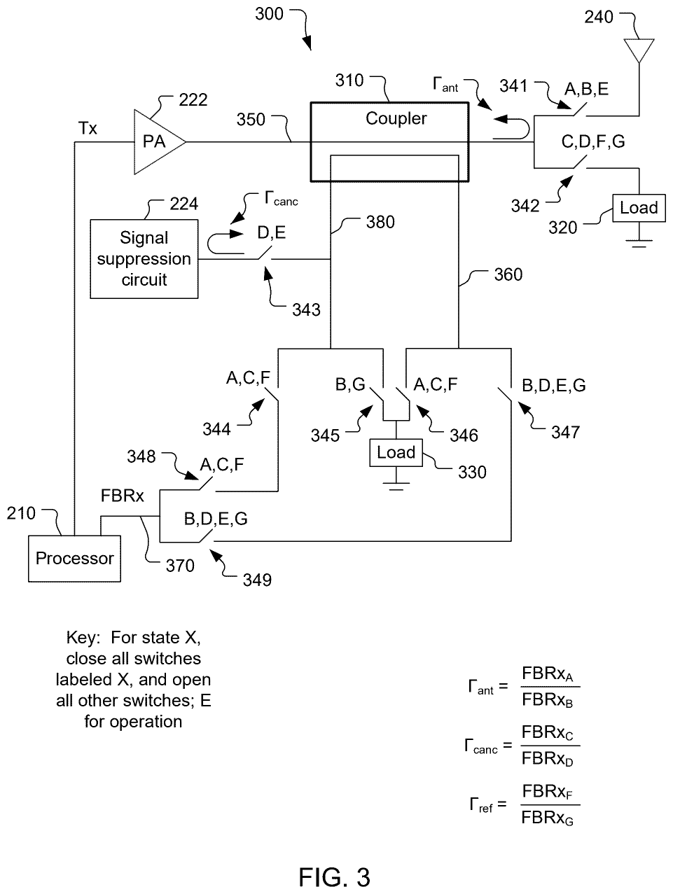

Referring also to FIG. 3, routing circuitry 300, which is an example of the routing circuitry 226, is shown communicatively coupled to the PA 222, the signal suppression circuit 224, the antenna 240, and the processor 210 (e.g., via one or more components not shown (e.g., ADC, LNA, DAC, etc.)). In this example, the routing circuitry 300 includes a coupler 310, a load 320, a load 330, and switches 341, 342, 343, 344, 345, 346, 347, 348, 349. The switches 344-347 may be implemented by a multiplexer and the switches 348, 349 may be implemented by another multiplexer. One of the switches 344, 348 and/or one of the switches 347, 349 may be omitted. Groups of components may be implemented together, e.g., in a single integrated circuit chip. For example, the signal suppression circuit 224 may be implemented together, e.g., in a single integrated circuit chip, and the routing circuitry 300 (or at least the switches 341-349) may be implemented together, e.g., in a single integrated circuit chip separate from the signal suppression circuit 224. Other components of the RFID reader 200 may be implemented separately, e.g., on a main printed circuit board (PCB) of the RFID reader 200, and coupled to the signal suppression circuit 224 and the routing circuitry 300. The transmit signal leakage may include energy that leaks directly from the transmit path to the receive path. Consequently, with the routing circuitry 300 including the loads 320, 330, a reference reflection coefficient Γ_{ref}, with a transmit line 350 connected to the load 320 and a receive line 360 connected to the load 330, may be determined and used to further mitigate transmit signal leakage during normal operation of the reader 200. For example, the processor 210 may control the impedance of the signal suppression circuit 224 to attempt to make the following relationship true

$${Γ}_{ant} + {Γ}_{c a n c} + {Γ}_{r e f} = 0 \qquad ( 2 )$$

The loads 320, 330 may be matched loads that closely match the impedance looking out from the loads 320, 330, respectively, such that the reference reflection coefficient Γ_{ref} is small. The reference reflection coefficient Γ_{ref} is effectively the antenna reflection coefficient with the antenna 240 replaced with the load 320. The switches 341, 342 may be eliminated from the routing circuitry 300, e.g., with a test connector provided near the antenna 240 and used when reference reflection coefficient measurements are taken, which can be stored in the memory 230 (e.g., in a look-up table (LUT) for later use. A transmit path in FIG. 3 includes the line 350, the coupler 310, and the switch 341. A receive path in FIG. 3 includes the switch 341, the coupler 310, the line 360, and the switches 347, 349. The coupler 310 may be a directional coupler configured to couple a portion of a transmit signal on the line 350 to a coupler line 380, configured to couple a signal reflected by the signal suppression circuit 224 from the line 380 to the line 360, and configured to couple a signal reflected by the antenna 240 (e.g., at an antenna port (e.g., at the switch 341) to the line 360.

The processor 210 is configured to control the switches 341-349 to implement ordinary operation (e.g., for obtaining information in the signal 252 from the RFID tag 250), or to implement a mitigation mode to determine the antenna reflection coefficient Γₐₙₜ, or to implement a calibration mode to determine the canceler reflection coefficient Γ_{canc}. As indicated in FIG. 3, respective ones of the switches 341-349 are closed for the modes A, B, C, D, E, F, G indicated for the respective ones of the switches 341-349, and each of the switches 341-349 is open for any of the modes A-G not indicated next to the switch 341-349. For example, the switch 341 is closed for modes A, B, and E, and open for modes C, D, F, and G.

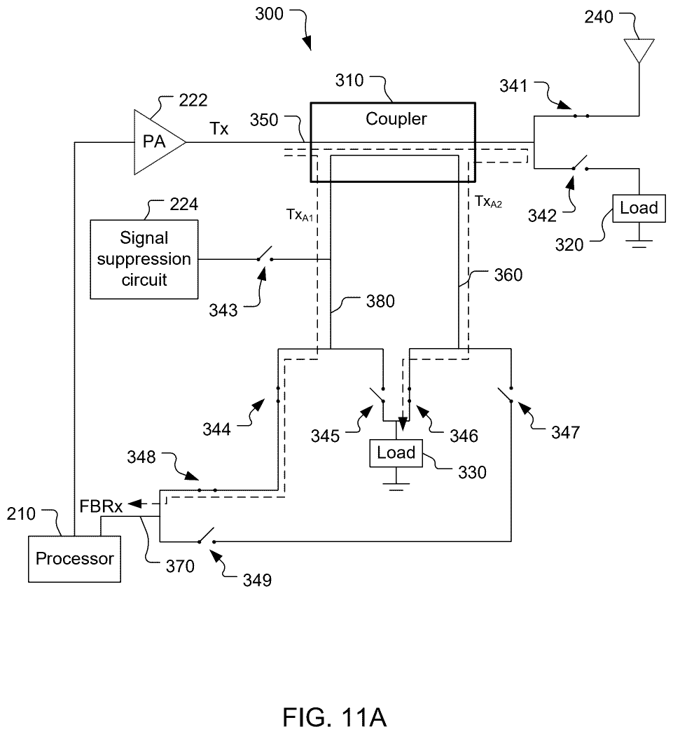

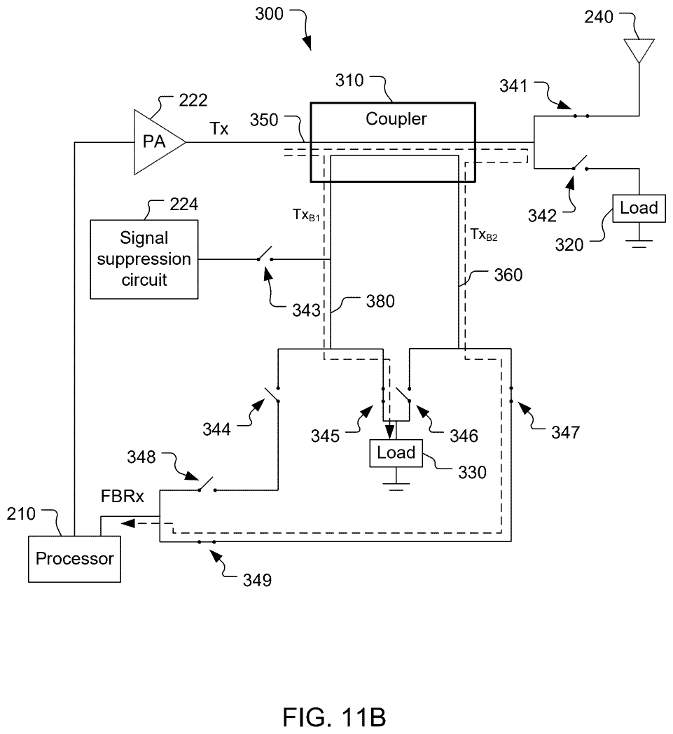

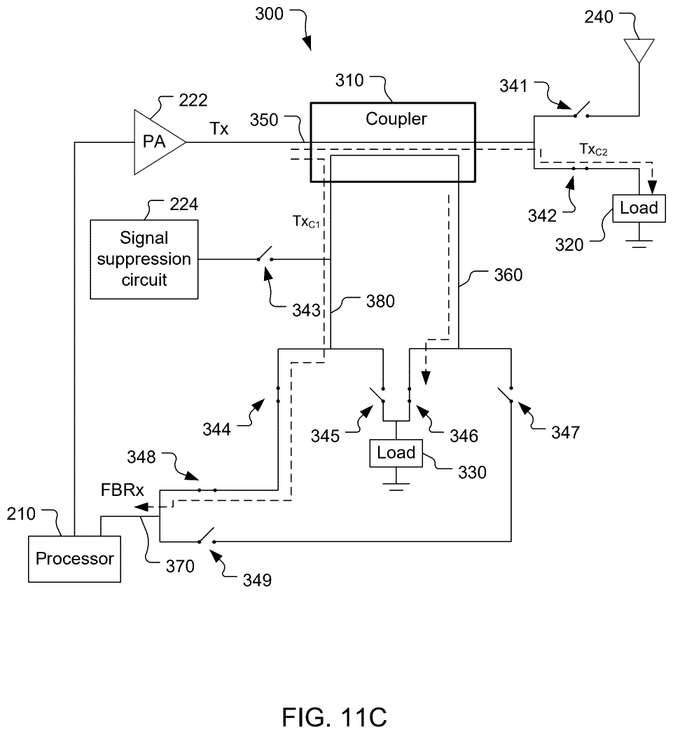

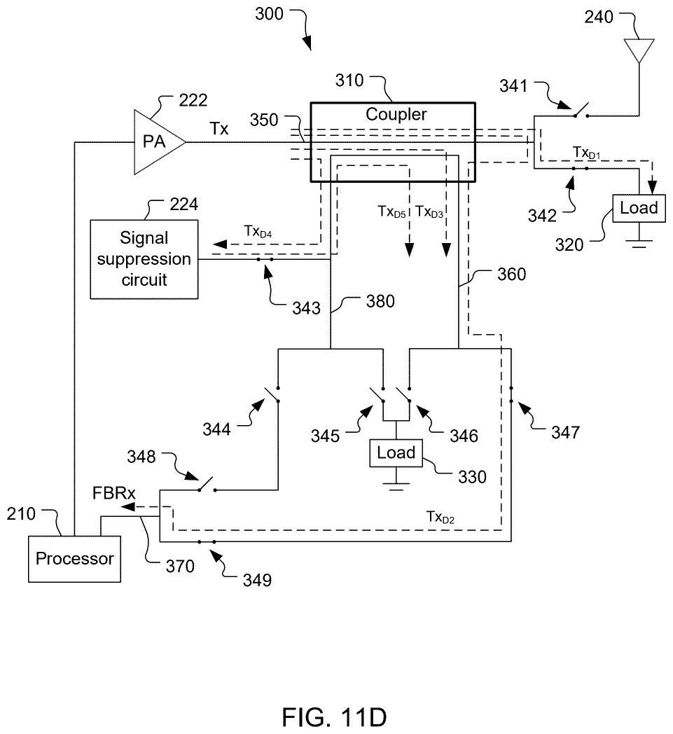

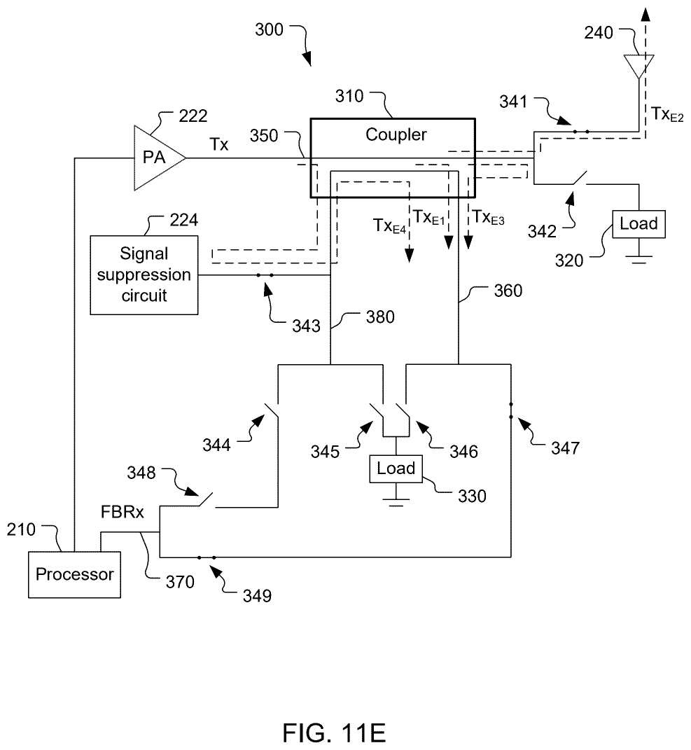

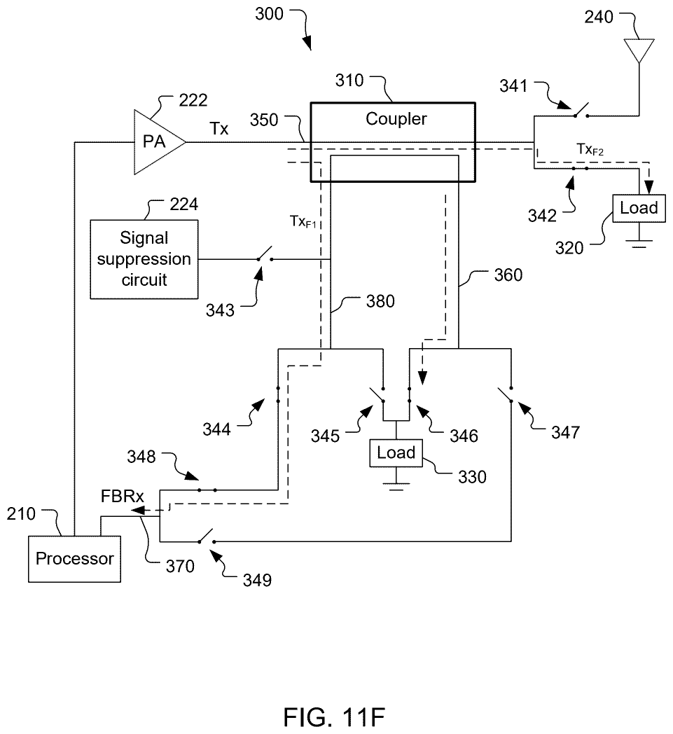

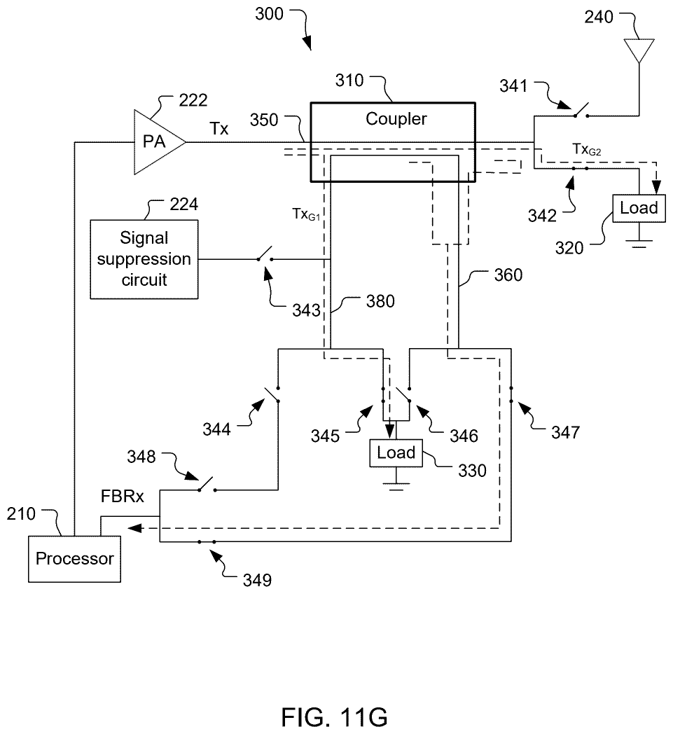

Referring also to FIG. 11E, to implement ordinary operation, the processor 210 controls the switches 341-349 to implement mode E (i.e., for the switches 341, 343, 347, 349 to be closed and for the switches 342, 344-346, 348 to be open). In this mode, one portion Tx_{E1} of a transmit signal Tx on the transmit line 350 will leak into the receive line 360 through the coupler 310, another portion Tx_{E2} will be transmitted by the antenna 240, and another portion Tx_{E3} will be reflected by the antenna 240 and directed to the receive line 360 by the coupler 310. In this mode, the directly-leaked signal portion and the antenna-reflected signal portion on the receive line 360 comprise the transmit signal leakage. Also in this mode, a portion of the transmit signal Tx on the transmit line 350 will be coupled through the coupler 310 and the switch 343 to the signal suppression circuit 224 via the coupler line 380, and at least some of this signal will be reflected by the circuit 224 (in accordance with the canceler reflection coefficient Γ_{canc}) and will be directed by the coupler 310 as a signal portion Tx_{E4} to the receive line 360 to destructively add with the transmit signal leakage.

To determine the antenna reflection coefficient Γₐₙₜ, the processor 210 may control the switches 341-349 to implement mode A at one time and mode B at another time. Referring also to FIG. 11A, in mode A, a portion Tx_{A1} of the transmit signal on the transmit line 350 will be coupled through the coupler 310 to the processor 210, and another portion Tx_{A2} will be reflected by the antenna 240 and directed to the load 330 via the receive line 360. Referring also to FIG. 11B, in mode B, a portion Tx_{B1} of the transmit signal on the transmit line 350 will be coupled through the coupler 310 to the load 330 via the coupler line 380, and another portion Tx_{B2} will be reflected by the antenna 240 and directed to the processor 210 via the receive line 360. The processor 210 may measure an FBRx signal (feedback receive signal) on an output line 370 during each of mode A and mode B (i.e., FBRx_{A}, FBRx_{B}, respectively), and determine a ratio of the FBRx signals in each of these modes to determine the antenna reflection coefficient Γₐₙₜ.

To determine the canceler reflection coefficient Γ_{canc} of the signal suppression circuit 224, the processor 210 may control the switches 341-349 to implement mode C at one time and mode D at another time. Referring also to FIG. 11C, in mode C, a portion Tx_{C1} of the transmit signal on the transmit line 350 will be coupled through the coupler 310 to the processor 210 via the coupler line 380, and another portion Tx_{C2} will be directed to the load 320, with any signal reflected by the load 320 or directly leaking to the receive line 360 being directed to the load 330. Referring also to FIG. 11D, in mode D, a portion Tx_{D1} of the transmit signal on the transmit line 350 will be directed to the load 320 via the coupler 310, another portion Tx_{D2} will be reflected by the load 320 and directed to the receive line 360 by the coupler 310, and another portion Tx_{D3} of the transmit signal on the transmit line 350 will directly leak into the receive line 360 through the coupler 310. In this mode, the directly-leaked signal portion Tx_{D3} and the load-reflected signal portion Tx_{D2} on the receive line 360 comprise the transmit signal leakage. Also in this mode, a portion Tx_{D4} of the transmit signal on the transmit line 350 will be coupled through the coupler 310 to the signal suppression circuit 224 via the coupler line 380, and at least some Tx_{D5} of this signal reflected by the circuit 224 (in accordance with the canceler reflection coefficient Γ_{canc}) will be directed by the coupler 310 to the receive line 360 to destructively add with the transmit signal leakage. The processor 210 may measure the FBRx signal provided on the output line 370 during each of mode C and mode D (i.e., FBRx_{C}, FBRx_{D}, respectively), and determine a ratio of the FBRx signals in each of these modes to determine the canceler reflection coefficient Γ_{canc}. To determine the reference reflection coefficient Γ_{ref}, the processor 210 may control the switches 341-349 to implement mode F at one time and mode G at another time. Referring also to FIG. 11F, in mode F, a portion Tx_{F1} of the transmit signal on the transmit line 350 will be coupled through the coupler 310 to the processor 210, and another portion Tx_{F2} will be directed to the load 320, with any signal reflected by the load 320 or directly leaking to the receive line 360 being directed to the load 330. Referring also to FIG. 11G, in mode G, a portion Tx_{G1} of the transmit signal on the transmit line 350 will be coupled through the coupler 310 to the load 330 via the coupler line 380, and another portion Tx_{G2} will be directed to the load 320, with any signal reflected by the load 320 or directly leaking to the receive line 360 being directed to the processor 210. The processor 210 may measure the FBRx signal during each of mode F and mode G (i.e., FBRx_{F}, FBRx_{G}, respectively), and determine a ratio of the FBRx signals in each of these modes to determine the reference reflection coefficient Γ_{ref}.

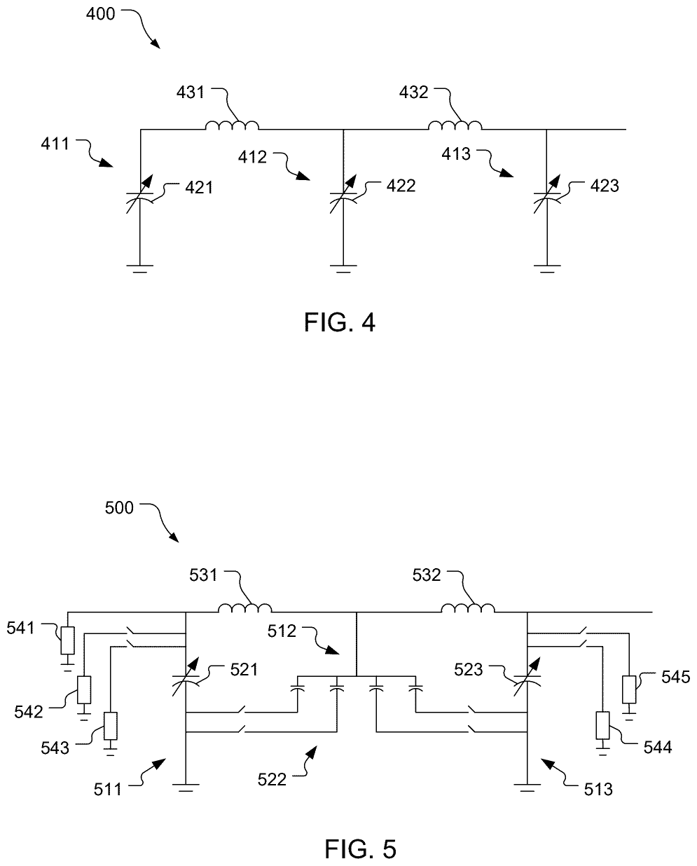

Referring also to FIGS. 4 and 5, the signal suppression circuit 224 is configured to provide multiple impedances. The signal suppression circuit 224 may include one or more variable-impedance components. For example, the signal suppression circuit 224 may comprise a double-pi circuit 400 including one or more variable-impedance components. In this example, the circuit 400 includes three legs 411, 412, 413, three variable capacitors 421, 422, 423, with each of the legs 411-413 including one of the variable capacitors 421-423 coupled to ground, and two inductors 431, 432 each coupled between a respective pair of the legs 411-413. The variable capacitors 421-423 may be implemented in a variety of known ways, e.g., each comprising multiple discrete capacitors that may be selectively included as part of the respective variable capacitor 421-423 (i.e., to selectively contribute to the capacitance provided by the respective variable capacitor 421-423). For example, the signal suppression circuit 224 may comprise a double-pi circuit 500 including three legs 511, 512, 513, three variable capacitors 521, 522, 523, with each of the legs 511-513 including one of the variable capacitors 521-523 coupled to ground, two inductors 531, 532 each coupled between a respective pair of the legs 511-513, and five resistors 541, 542, 543, 544, 545, with each of the resistors 542-545 selectively coupled to one of the legs 511, 513, respectively.

In the circuit 500, the variable capacitor 522 comprises multiple (here four) discrete capacitors each selectively coupled to ground by a respective switch. One or more of the variable capacitors 521, 523 may include multiple discrete capacitors that may be selectively included as part of the respective variable capacitor 521, 523. The processor 210 may control the switches of the circuit 500 to selectively include one or more of the discrete capacitors of the variable capacitor 522 to provide a desired capacitance, and possibly to include one or more of the resistors 542-545 as part of the signal suppression circuit 500 (i.e., to be part(s) of the impedance provided by the signal suppression circuit 500).

The signal suppression circuit 500 may provide numerous different impedances. For example, with the variable capacitor 522 including two discrete capacitors, each of the variable capacitors 521, 523 comprising five discrete capacitors, and the four selectable resistors 542-545, the processor 210 may implement 256 different impedances of the signal suppression circuit 500.

Impedance values of components of the signal suppression circuit 500 (or the signal suppression circuit 224 generally) may be selected to provide impedances that may be used to mitigate (i.e., at least partially offset (cancel)) transmit signal leakage (e.g., at least partially destructively combine with a portion of a transmit signal that leaks into a receive path) over a large frequency bandwidth and/or to provide fine frequency resolution of transmit signal leakage mitigation. For example, large resistance values such as 500Ω for the resistors 542, 545, and 1,000Ω for the resistors 543, 544 may provide for transmit signal leakage mitigation over a wide frequency range. Smaller resistance values may be used to provide finer frequency resolution, corresponding to finer increments in Γ_{canc}. Capacitance values of discrete capacitors may be selected that are close to each other (e.g., 0.5 pF, 1 pF, 2 pF, 4 pF, respectively for the variable capacitor 522) to provide fine frequency resolution for transmit signal leakage mitigation. The resistor 541 may be provided for balance and may have any of a variety of impedance values, e.g., 50Ω, 70Ω, or another value. As shown in FIG. 5, the resistor 541 is permanently connected to the leg 511, but other configurations are possible, e.g., where the resistor 541 is selectively coupled to the leg 511 by a switch.

The circuits 400, 500 are examples and numerous other configurations of signal suppression circuits may be used. For example, a pi-circuit suppression circuit may include one or more variable reactances, and may have a different quantity of variable reactances than the circuit 400. For example, a pi-circuit suppression circuit may have one or two of the capacitors 421-423, but not all of the capacitors 421-423, be variable. As another example, a pi-circuit suppression circuit may include one or more variable inductances (e.g., each implemented by a selectable set of discrete inductances) in addition to or instead of one or more variable capacitors. As another example, other quantities of discrete capacitors than discussed may be used for any of the variable capacitors 521-523. As discussed above, groups of components may be implemented together, e.g., in a single integrated circuit chip. For example, multiple elements or all elements of the signal suppression circuit 500 may be implemented together, e.g., in a single integrated circuit chip. In some such examples, all of the switches in the signal suppression circuit 500 are implemented together in a single integrated circuit chip. In another example, all of the switches in the left half of the signal suppression circuit 500 (as illustrated in FIG. 5) and optionally the variable capacitor 521 are implement in a single integrated circuit chip or package, and all of the switches in the right half of the signal suppression circuit 500 (as illustrated in FIG. 5) and optionally the variable capacitor 523 are implement in another single integrated circuit chip or package, while other components of the signal suppression circuit 500 are implemented separately, e.g., on a main printed circuit board (PCB) of the RFID reader 200.

The processor 210 may be configured to determine different values of the canceler coefficient Γ_{canc} for use in transmit signal leakage mitigation. For example, the processor 210 may control the signal suppression circuit 224 to implement different impedances, and for each impedance, to control the routing circuitry to implement modes C and D, to measure the FBRx signal provided on the output line 370 during each of mode C and mode D, to determine the ratio of the FBRx signal for each of these modes, and to store the corresponding canceler reflection coefficient value in the memory 230, e.g., in an LUT of the impedance (and/or setting(s) of the circuit 224 producing the impedance) and the canceler reflection coefficient value. Thus, the processor 210 may determine the canceler reflection coefficient Γ_{canc} based on signals received on a single transmission line, the output line 370.

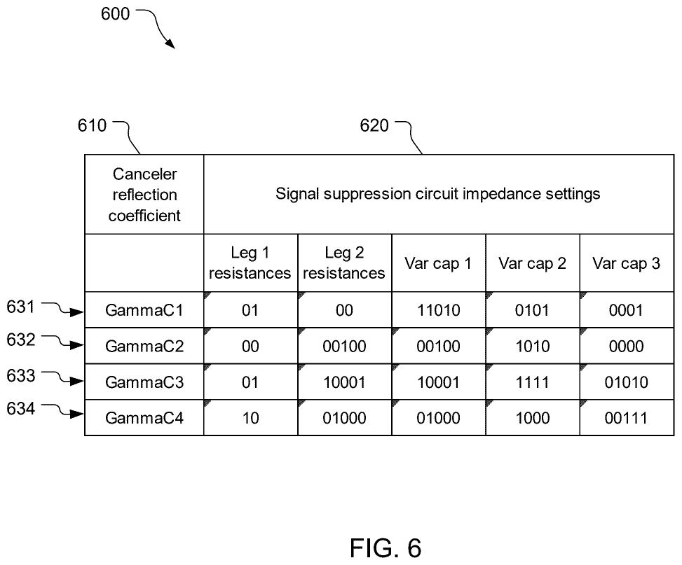

Referring also to FIG. 6, the processor 210 may store an LUT 600 in the memory 230 that maps canceler reflection coefficient values to one or more corresponding impedance settings of the signal suppression circuit 224. In this example, the LUT 600 includes canceler reflection coefficient values 610 and signal suppression circuit impedance settings 620 for each of four entries 631, 632, 633, 634. This example corresponds to the signal suppression circuit 500, with the variable capacitors 521, 523 each being 5-bit capacitors (i.e., having five discrete capacitors that may be selectively included (e.g., in parallel)). Only the four entries 631-634 are shown, but the LUT 600 (and/or another LUT) may include other quantities of entries, e.g., 256 entries in view of the four resistors, two 5-bit variable capacitors, and one 4-bit variable capacitor of this example. Generic values (GammaCX) of the canceler reflection coefficient are provided, while bit indications for the resistors 542-545 and the discrete capacitors are indicated, with a “1” indicating to include the component (close the corresponding switch) and a “0” indicating to leave the component out (open the corresponding switch).

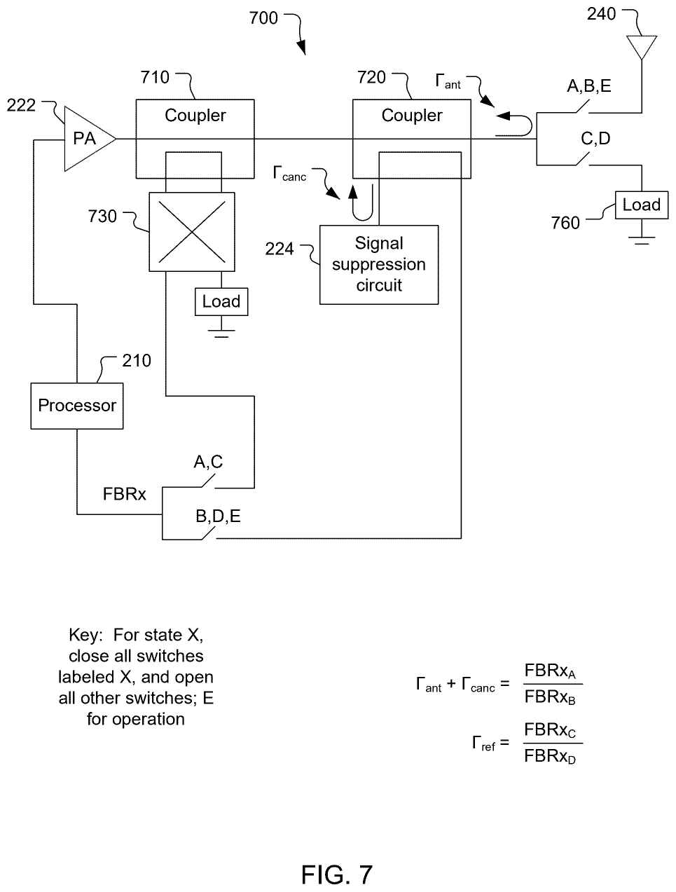

Referring also to FIG. 7, routing circuitry 700, which is another example configuration of the routing circuitry 226, is shown communicatively coupled to the PA 222, the signal suppression circuit 224, the antenna 240, and the processor 210 (e.g., via one or more components not shown (e.g., ADC, LNA, DAC, etc.)). The routing circuitry 700 includes two couplers 710, 720, a switch 730 (a cross switch or switch matrix), and fewer mode switches (i.e., switches selected to implement various modes) than the routing circuitry 300. The switch 730 enables selection of the portion of the transmit signal coupled by the coupler 710 to the switch 730 or the portion of the signal reflected by the antenna 240 coupled by the couplers 710, 720 to the switch 730. The routing circuitry 700 may be advantageous, for example, if the transceiver 220 is not fully integrated, e.g., being implemented with previously-existing components/circuits. With a matched (e.g., 5052) load 760 connected at the antenna port, Γₐₙₜ=0 and Γ_{canc} can be measured. Still other routing circuitry configurations may be used. For example, the routing circuitry 700 may be physically disposed as shown in FIG. 7, but other physical arrangements may be used, e.g., with the physical positions of the couplers 710, 720 swapped.

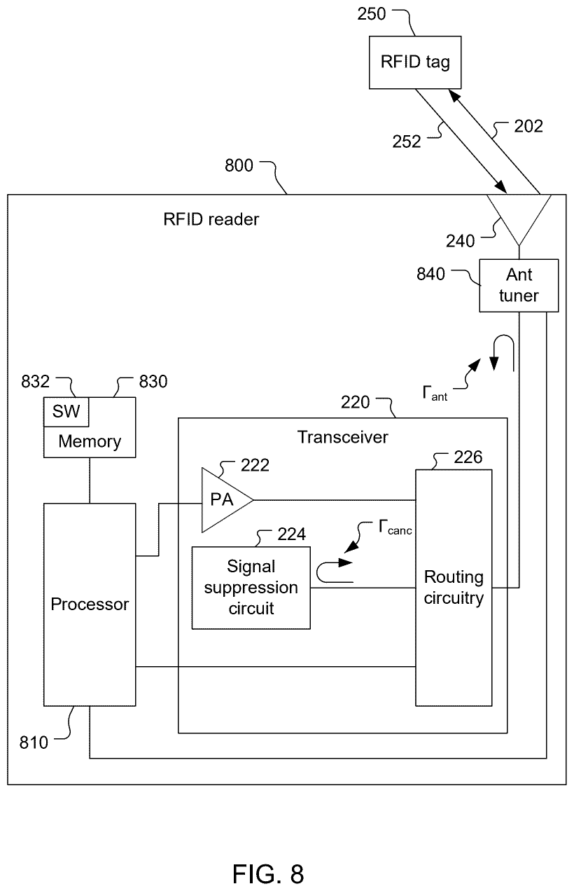

Referring also to FIG. 8, an RFID reader 800, which is another example of the RFID reader 110, is similar to the RFID reader 200, but also includes an antenna tuner 840 communicatively coupled between the antenna 240 and the transceiver 220, and includes a processor 810 and a memory 830 (with software 832) configured to control the antenna tuner 840 and mitigate transmit signal leakage as discussed herein. The processor 810 is communicatively coupled to the antenna tuner 840 and configured to control an impedance of the antenna tuner 840. The processor 810 may control the antenna tuner impedance, e.g., to attempt to reduce impedance discontinuity between an antenna input impedance presented by the antenna tuner 840 and the antenna 240, and an impedance presented to the antenna tuner 840 by the transceiver 220, and thus reduce Γₐₙₜ.

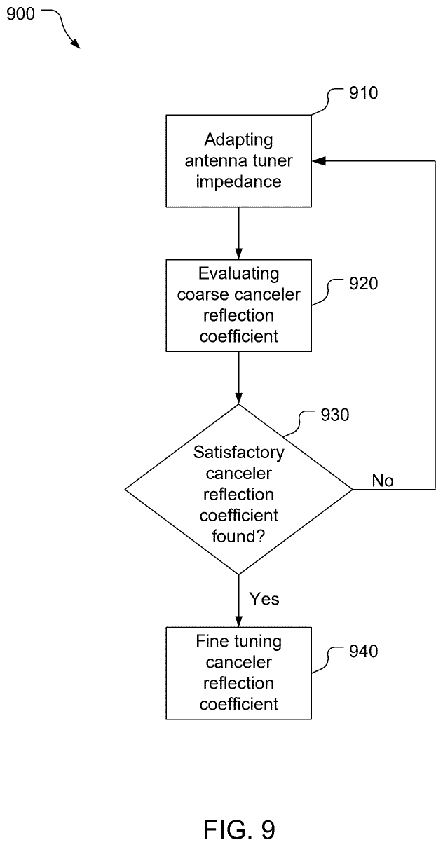

Referring to FIG. 9, with further reference to FIG. 8, a method 900 of RFID reader transmit signal leakage mitigation includes the stages shown. The method 900 is, however, an example and not limiting. The method 900 may be altered, e.g., by having one or more stages added, removed, rearranged, combined, performed concurrently, and/or having one or more stages each split into multiple stages.

At stage 910, the method 900 includes adapting the antenna tuner impedance. For example, the processor 810 may instruct the antenna tuner 840 to provide different impedances and, for each different impedance, determine the antenna reflection coefficient Γₐₙₜ. The processor 810 may set the impedance of the antenna tuner 840 to the impedance that yields the lowest value of the antenna reflection coefficient Γₐₙₜ from the determined values of the antenna reflection coefficient Γₐₙₜ, and thus the lowest value within the resolution of the RFID reader 800, although possibly not the theoretically lowest value achievable.

At stage 920, the method 900 includes evaluating coarse canceler reflection coefficients. For example, the processor 810 may determine the antenna reflection coefficient Γₐₙₜ and search for a stored canceler reflection coefficient Γ_{canc} in order to try to satisfy Equation (1) or Equation (2).

At stage 930, the method 900 includes determining whether a satisfactory value of the canceler reflection coefficient Γ_{canc} has been found. For example, the processor 810 may determine whether a value of the canceler reflection coefficient Γ_{canc} has been found to cancel the value of the antenna reflection coefficient Γₐₙₜ (and possibly the reference reflection coefficient Γ_{ref}) within a threshold of complete cancelation, e.g., whether

$${Γ}_{ant} + {Γ}_{c a n c} + {Γ}_{ref} < Threshold \qquad ( 3 )$$

If the processor 810 is unable to find a value of the canceler reflection coefficient Γ_{canc} that will cause Inequality (3) to be satisfied, then the method 900 returns to stage 910. If the processor 810 is able to find a value of the canceler reflection coefficient Γ_{canc} that will cause Inequality (3) to be satisfied, then the method 900 proceeds to stage 940.

At stage 940, the method 900 includes fine tuning the canceler reflection coefficient. For example, the processor 810 may alter the signal suppression circuit 224 to implement canceler reflection coefficient Γ_{canc} values near the canceler reflection coefficient Γ_{canc} value found at stage 920 that satisfied Inequality (3), and for each such canceler reflection coefficient Γ_{canc} value, determine an RSSI (Received Signal Strength Indicator) value of the FBRx signal. The processor 810 may select the canceler reflection coefficient Γ_{canc} value, from the evaluated values, that yields the lowest RSSI.

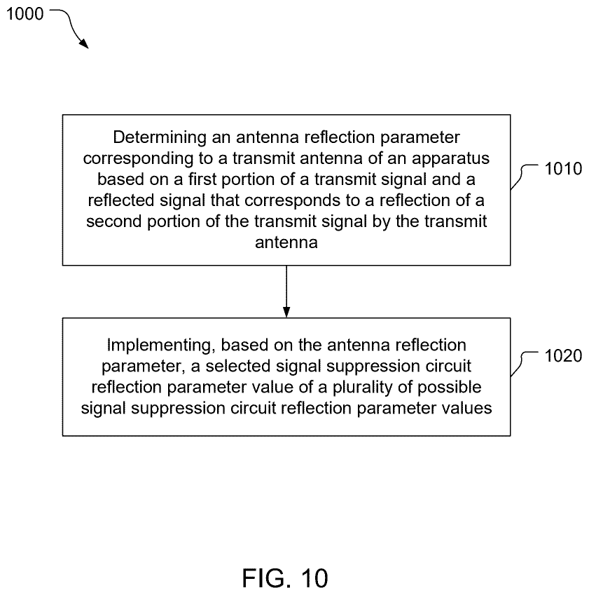

Referring to FIG. 10, with further reference to FIGS. 1-9, a method 1000 of transmit signal leakage mitigation in an apparatus includes the stages shown. The method 1000 is, however, an example and not limiting. The method 1000 may be altered, e.g., by having one or more stages added, removed, rearranged, combined, performed concurrently, and/or having one or more stages each split into multiple stages.

At stage 1010, the method 1000 includes determining an antenna reflection parameter corresponding to a transmit antenna of the apparatus based on a first portion of a transmit signal and a reflected signal that corresponds to a reflection of a second portion of the transmit signal by the transmit antenna. For example, the processor 210 may determine the antenna reflection coefficient Γₐₙₜ based on the portion Tx_{A1} of a transmit signal on the line 350 coupled to the line 380 by the coupler 310 and provided to the processor 210 by the switches 344, 348 in mode A of the routing circuitry 300, and based on the portion Tx_{B2} of the transmit signal that is passed through the coupler 310 to the antenna 240, reflected by the antenna 240, provided to the line 360 by the coupler 310, and provided to the processor by the switches 347, 349 in mode B of the routing circuitry 300. The processor 210, in combination with the memory 230, may comprise means for determining the antenna reflection parameter.

At stage 1020, the method 1000 includes implementing, based on the antenna reflection parameter, a selected signal suppression circuit reflection parameter value of a plurality of possible signal suppression circuit reflection parameter values. For example, the processor 210 may select a canceler reflection coefficient from canceler reflection coefficients providable by the signal suppression circuit 224, e.g., included a look-up table, based on the antenna reflection coefficient, e.g., to offset the antenna reflection coefficient. The processor 210 can instruct the signal suppression circuit 224 to implement the selected signal suppression circuit reflection parameter value, e.g., by implementing an instructed impedance value (e.g., by including indicated components in the signal suppression circuit 224 such as capacitors and resistors indicated in respective bit codes, e.g., as discussed with respect to FIGS. 5 and 6). The processor 210, possibly in combination with the memory 230, in combination with the signal suppression circuit 224 may comprise means for implementing the selected signal suppression circuit reflection parameter value.

Implementations of the method 1000 may include one or more of the following features. In an example implementation, determining the antenna reflection parameter comprises determining the antenna reflection parameter intermittently over time. Because the antenna reflection parameter may change over time with changing conditions, the processor 210 may determine the antenna reflection parameter multiple times over time. In a further example implementation, the method 1000 includes, between consecutive determinations of the antenna reflection parameter: routing the first portion of the transmit signal to a signal suppression circuit; routing a third portion of the transmit signal corresponding to a reflection of the first portion of the transmit signal by the signal suppression circuit, to a processor of the apparatus; and routing the reflected signal to the processor. For example, the processor 210 may implement normal operation between determinations of the antenna reflection parameter, e.g., by implementing mode E of the circuit of FIG. 3 or of the circuit of FIG. 7. The coupler 310, and the switches 341-349 may comprise means for routing the first portion of the transmit signal, the third portion of the transmit signal, and the reflected signal.

Also or alternatively, implementations of the method 1000 may include one or more of the following features. In an example implementation, determining the antenna reflection parameter comprises: routing, at a first time, the first portion of the transmit signal to a processor of the apparatus; routing, at a second time that is different from the first time, the reflected signal to the processor; and determining the antenna reflection parameter based on a ratio of the first portion of the transmit signal at the first time and the reflected signal at the second time. For example, the processor 210 may control the routing circuitry 300 to implement mode A of the circuit of FIG. 3 at one time (for a first duration), implement mode B of the circuit of FIG. 3 at another time (before or after the time during which mode A is implemented, and for a second duration), and may determine the antenna reflection coefficient Γₐₙₜ based on a ratio of the FBRx signal received during mode A and the FBRx signal received during mode B. The coupler 310 and the switches 344, 348 may comprise means for routing the first portion of the transmit signal at the first time to the processor. The coupler 310 and the switches 347, 349 may comprise means for routing the reflected signal at the second time to the processor. In another example implementation, the method 1000 includes determining each of the plurality of possible signal suppression circuit reflection parameter values by, for each of a plurality of possible impedance values of a signal suppression circuit: routing, at a first time, the first portion of the transmit signal to a processor of the apparatus; routing, to the processor at a second time that is different from the first time, the first portion of the transmit signal to the signal suppression circuit and a third portion of the transmit signal corresponding to a reflection of the first portion of the transmit signal by the signal suppression circuit; and determining a ratio of the first portion of the transmit signal at the first time and a combination of the third portion of the transmit signal and the reflected signal at the second time. For example, the processor 210 may control the routing circuitry 300 to implement mode C of the circuit of FIG. 3 for some amount of time during which the portion Tx_{C1} of the transmit signal on line 350 is provided to the line 380 by the coupler 310 and to the processor 210 by the switches 344, 348. The processor 210 may control the routing circuitry 300 to implement mode D of the circuit of FIG. 3 for some amount of time during which the portion Tx_{D5} of the transmit signal on line 350 is provided to the line 380 by the coupler 310, reflected by the signal suppression circuit 224, provided to the line 360 by the coupler 310, and provided to the processor 210 by the switches 347, 349. The processor 210 may determine the canceler reflection coefficient Γ_{canc} based on a ratio of the FBRx signal received during mode C and the FBRx signal received during mode D. The processor 210 may perform this process for multiple ones (e.g., all) possible Γ_{canc} values (corresponding to respective impedance values) of the signal suppression circuit 224. The coupler 310 and the switches 344, 348 may comprise means for routing the first portion of the transmit signal at the first time to the processor. The coupler 310 and the switch 343 may comprise routing the first portion of the transmit signal to the signal suppression circuit at the first time, and the coupler 310 and the switches 347, 349 may comprise means for routing the third portion of the transmit signal to the processor at the second time. The processor 210, possibly in combination with the memory 230, may comprise means for determining each of the plurality of possible signal suppression circuit reflection parameter values.

Also or alternatively, implementations of the method 1000 may include one or more of the following features. In an example implementation, implementing the selected signal suppression circuit reflection parameter value comprises implementing the selected signal suppression circuit reflection parameter value such that the selected signal suppression circuit reflection parameter value offsets, at least partially, the antenna reflection parameter. For example, the processor 210 controls the signal suppression circuit 224 to implement the Γ_{canc} based on Equation (1). In a further example implementation, implementing the selected signal suppression circuit reflection parameter value comprises implementing the selected signal suppression circuit reflection parameter value such that the selected signal suppression circuit reflection parameter value offsets, at least partially, a combination of the antenna reflection parameter and a reference reflection parameter. For example, the processor 210 controls the signal suppression circuit 224 to implement the Γ_{canc} based on Equation (2). In a further example implementation, the method 1000 includes determining the reference reflection parameter by: routing, at a first time, the first portion of the transmit signal to a processor of the apparatus, the second portion of the transmit signal to a first load, and a load-reflected signal, corresponding to a reflection of the second portion of the transmit signal by the first load, to a second load; routing, at a second time different from the first time, the first portion of the transmit signal to the second load, the second portion of the transmit signal to the first load, and the load-reflected signal to the processor; and determining the reference reflection parameter based on a ratio of the first portion of the transmit signal at the first time and the load-reflected signal at the second time. For example, the processor 210 may control the routing circuitry 300 to implement mode F of the circuit of FIG. 3 for some amount of time during which the portion Tx_{F1} of the transmit signal on line 350 is provided to the line 380 by the coupler 310 and to the processor 210 by the switches 344, 348. Also during this time, the portion Tx_{F2} of the transmit signal from line 350 is provided by the coupler 310 and the switch 342 to the load 320 and a portion of this signal that is reflected by the load 320 is provided by the switch 342, the coupler 310, and the switch 346 to the load 330. The processor 210 may control the routing circuitry 300 to implement mode G of the circuit of FIG. 3 for some amount of time during which the portion Tx_{G1} of the transmit signal on the line 350 is provided by the coupler 310 to the line 380 and by the switch 345 to the load 330. Also during this time, the portion Tx_{G2} of the transmit signal from line 350 is provided by the coupler 310 and the switch 342 to the load 320 and a portion of this signal that is reflected by the load 320 is provided by the switch 342, the coupler 310, and the switches 347, 349 to the processor 210. The processor 210 may determine the reference reflection coefficient Γₐₙₜ based on a ratio of the FBRx signal received during mode F and the FBRx signal received during mode G. The coupler 310 and the switches 344, 348 may comprise means for routing the first portion of the transmit signal at the first time. The coupler 310 and the switch 342 may comprise means for routing the second portion of the transmit signal at the first time. The coupler 310 and the switches 342, 346 may comprise means for routing the load-reflected signal at the first time. The coupler 310 and the switch 345 may comprise means for routing the first portion of the transmit signal at the second time. The coupler 310 and the switch 342 may comprise means for routing the second portion of the transmit signal at the second time. The coupler 310 and the switches 342, 347, 349 may comprise means for routing the load-reflected signal at the second time. The processor 210, possibly in combination with the memory 230, may comprise means for determining the reference reflection parameter.

Also or alternatively, implementations of the method 1000 may include one or more of the following features. In an example implementation, the method 1000 further includes determining the plurality of possible signal suppression circuit reflection parameter values, wherein determining the antenna reflection parameter and determining the plurality of possible signal suppression circuit reflection parameter values are both based on test signals received by a processor of the apparatus at respective times from the same single transmission line. For example, the processor 210 receives signals on the same line, e.g., the line 370, during various modes and uses the signals from this same line to determine reflection coefficients, e.g., to mitigate transmit signal leakage (e.g., suppress (e.g., at least partially cancel) a portion of a transmit signal that leaks into a receive path of the apparatus. In another example implementation, the apparatus comprises an RFID reader.

### Implementation Examples

Implementation examples are provided in the following numbered clauses.
Clause 1. A method, for transmit signal leakage mitigation in an apparatus, comprising:
determining an antenna reflection parameter corresponding to a transmit antenna of the apparatus based on a first portion of a transmit signal and a reflected signal that corresponds to a reflection of a second portion of the transmit signal by the transmit antenna; and
implementing, based on the antenna reflection parameter, a selected signal suppression circuit reflection parameter value of a plurality of possible signal suppression circuit reflection parameter values.
Clause 2. The method of clause 1, wherein determining the antenna reflection parameter comprises determining the antenna reflection parameter intermittently over time.
Clause 3. The method of either clause 1 or clause 2, further comprising, between consecutive determinations of the antenna reflection parameter:
routing the first portion of the transmit signal to a signal suppression circuit;
routing a third portion of the transmit signal corresponding to a reflection of the first portion of the transmit signal by the signal suppression circuit, to a processor of the apparatus; and
routing the reflected signal to the processor.
Clause 4. The method of any of clauses 1-3, wherein determining the antenna reflection parameter comprises:
routing, at a first time, the first portion of the transmit signal to a processor of the apparatus;
routing, at a second time that is different from the first time, the reflected signal to the processor; and
determining the antenna reflection parameter based on a ratio of the first portion of the transmit signal at the first time and the reflected signal at the second time.
Clause 5. The method of any of clauses 1-4, further comprising determining each of the plurality of possible signal suppression circuit reflection parameter values by, for each of a plurality of possible impedance values of a signal suppression circuit:
routing, at a first time, the first portion of the transmit signal to a processor of the apparatus;
routing, to the processor at a second time that is different from the first time, the first portion of the transmit signal to the signal suppression circuit and a third portion of the transmit signal corresponding to a reflection of the first portion of the transmit signal by the signal suppression circuit; and
determining a ratio of the first portion of the transmit signal at the first time and a combination of the third portion of the transmit signal and the reflected signal at the second time.
Clause 6. The method of any of clauses 1-5, wherein implementing the selected signal suppression circuit reflection parameter value comprises implementing the selected signal suppression circuit reflection parameter value such that the selected signal suppression circuit reflection parameter value offsets, at least partially, the antenna reflection parameter.
Clause 7. The method of clause 6, wherein implementing the selected signal suppression circuit reflection parameter value comprises implementing the selected signal suppression circuit reflection parameter value such that the selected signal suppression circuit reflection parameter value offsets, at least partially, a combination of the antenna reflection parameter and a reference reflection parameter.
Clause 8. The method of clause 7, further comprising determining the reference reflection parameter by:
routing, at a first time, the first portion of the transmit signal to a processor of the apparatus, the second portion of the transmit signal to a first load, and a load-reflected signal, corresponding to a reflection of the second portion of the transmit signal by the first load, to a second load;
routing, at a second time different from the first time, the first portion of the transmit signal to the second load, the second portion of the transmit signal to the first load, and the load-reflected signal to the processor; and
determining the reference reflection parameter based on a ratio of the first portion of the transmit signal at the first time and the load-reflected signal at the second time.
Clause 9. The method of any of clauses 1-8, further comprising determining the plurality of possible signal suppression circuit reflection parameter values, wherein determining the antenna reflection parameter and determining the plurality of possible signal suppression circuit reflection parameter values are both based on test signals received by a processor of the apparatus at respective times from the same single transmission line.
Clause 10. The method of any of clauses 1-9, wherein the apparatus is an RFID reader (Radio Frequency Identification reader).
Clause 11. An apparatus comprising:
a power amplifier;
a transmit antenna;
a memory;
a signal suppression circuit having a plurality of possible signal suppression circuit reflection parameter values;
routing circuitry, communicatively coupled to the power amplifier, the transmit antenna, and the signal suppression circuit; and
a processor, communicatively coupled to the memory, the signal suppression circuit, and the routing circuitry, configured to:
   determine an antenna reflection parameter based on a first portion of a transmit signal from the power amplifier and a reflected signal that corresponds to a reflection, by the transmit antenna, of a second portion of the transmit signal from the power amplifier; and
   control, based on the antenna reflection parameter, the signal suppression circuit to implement a selected signal suppression circuit reflection parameter value of the plurality of possible signal suppression circuit reflection parameter values.
Clause 12. The apparatus of clause 11, wherein the processor is configured to determine the antenna reflection parameter intermittently over time.
Clause 13. The apparatus of either clause 11 or clause 12, wherein the processor is configured to cause the routing circuitry, between consecutive determinations of the antenna reflection parameter, to:
route the first portion of the transmit signal to the signal suppression circuit;
route, to the processor, a third portion of the transmit signal corresponding to a reflection of the first portion of the transmit signal by the signal suppression circuit; and
route the reflected signal to the processor.
Clause 14. The apparatus of any of clauses 11-13, wherein the routing circuitry comprises at least one coupler and a plurality of switches, and wherein the processor is configured to:
cause, at a first time, some of the plurality of switches, of the routing circuitry, to selectively communicatively couple the power amplifier to the processor via the at least one coupler to provide the first portion of the transmit signal to the processor;
cause, at a second time that is different from the first time, the plurality of switches to selectively communicatively couple the transmit antenna to the processor via the at least one coupler to provide the reflected signal to the processor; and
determine the antenna reflection parameter based on a ratio of the first portion of the transmit signal at the first time and the reflected signal at the second time.
Clause 15. The apparatus of any of clauses 11-14, wherein the routing circuitry comprises at least one coupler and a plurality of switches, and wherein the processor is configured to determine each of the plurality of possible signal suppression circuit reflection parameter values by, for each of a plurality of possible impedance values of the signal suppression circuit:
causing, at a first time, some of the plurality of switches, of the routing circuitry, to selectively communicatively couple the power amplifier to the processor via the at least one coupler to provide the first portion of the transmit signal to the processor;
causing, at a second time that is different from the first time, the plurality of switches to: route the first portion of the transmit signal to the signal suppression circuit; and route, to the processor, a third portion of the transmit signal corresponding to a reflection of the first portion of the transmit signal by the signal suppression circuit; and
determining a ratio of the first portion of the transmit signal at the first time and a combination of the third portion of the transmit signal and the reflected signal at the second time.
Clause 16. The apparatus of any of clauses 11-15, wherein the processor is configured to control the signal suppression circuit such that the selected signal suppression circuit reflection parameter value offsets, at least partially, the antenna reflection parameter.
Clause 17. The apparatus of clause 16, wherein the processor is configured to control the signal suppression circuit such that the selected signal suppression circuit reflection parameter value offsets, at least partially, a combination of the antenna reflection parameter and a reference reflection parameter.
Clause 18. The apparatus of clause 17, wherein the routing circuitry comprises at least one coupler and a plurality of switches, and wherein to determine the reference reflection parameter the processor is configured to:
cause, at a first time, the plurality of switches to: selectively communicatively couple the power amplifier to the processor via the at least one coupler to provide the first portion of the transmit signal to the processor; selectively communicatively couple the power amplifier to a first load to provide the second portion of the transmit signal to the first load; and selectively communicatively couple the first load to a second load via the at least one coupler to provide a load-reflected signal, corresponding to a reflection of the second portion of the transmit signal by the first load, to the second load;
cause, at a second time different from the first time, the plurality of switches to: selectively communicatively couple the power amplifier to the second load via the at least one coupler to provide the first portion of the transmit signal to the second load; selectively communicatively couple the power amplifier to the first load to provide the second portion of the transmit signal to the first load; and selectively communicatively couple the first load to the processor via the at least one coupler to provide the load-reflected signal to the processor; and
determine the reference reflection parameter based on a ratio of the first portion of the transmit signal at the first time and the load-reflected signal at the second time.
Clause 19. The apparatus of any of clauses 11-18, wherein the routing circuitry is configured to provide test signals, at respective times, on the same transmission line to the processor for the processor to determine the antenna reflection parameter and to determine the plurality of possible signal suppression circuit reflection parameter values.
Clause 20. The apparatus of any of clauses 11-19, wherein the signal suppression circuit comprises a double-pi circuit including a variable capacitor in each of three legs of the double-pi circuit and a plurality of inductances each communicatively coupled between a respective pair of the three legs of the double-pi circuit.
Clause 21. The apparatus of any of clauses 11-20, wherein the apparatus is an RFID reader (Radio Frequency Identification reader).
Clause 22. An apparatus comprising:
means for determining an antenna reflection parameter corresponding to a transmit antenna of the apparatus based on a first portion of a transmit signal and a reflected signal that corresponds to a reflection of a second portion of the transmit signal by the transmit antenna; and
means for implementing, based on the antenna reflection parameter, a selected signal suppression circuit reflection parameter value of a plurality of possible signal suppression circuit reflection parameter values.
Clause 23. The apparatus of clause 22, wherein the means for determining the antenna reflection parameter comprise means for determining the antenna reflection parameter intermittently over time.
Clause 24. The apparatus of either clause 22 or clause 23, further comprising means for routing, between consecutive determinations of the antenna reflection parameter, the first portion of the transmit signal to a signal suppression circuit, a third portion of the transmit signal corresponding to a reflection of the first portion of the transmit signal by the signal suppression circuit to a processor of the apparatus, and the reflected signal to the processor.
Clause 25. The apparatus of any of clauses 22-24, wherein the means for determining the antenna reflection parameter comprise:
means for routing, at a first time, the first portion of the transmit signal to a processor of the apparatus;
means for routing, at a second time that is different from the first time, the reflected signal to the processor; and
means for determining the antenna reflection parameter based on a ratio of the first portion of the transmit signal at the first time and the reflected signal at the second time.
Clause 26. The apparatus of any of clauses 22-25, further comprising means for determining each of the plurality of possible signal suppression circuit reflection parameter values by, for each of a plurality of possible impedance values of a signal suppression circuit:
routing, at a first time, the first portion of the transmit signal to a processor of the apparatus;
routing, to the processor at a second time that is different from the first time, the first portion of the transmit signal to the signal suppression circuit and a third portion of the transmit signal corresponding to a reflection of the first portion of the transmit signal by the signal suppression circuit; and
determining a ratio of the first portion of the transmit signal at the first time and a combination of the third portion of the transmit signal and the reflected signal at the second time.
Clause 27. The apparatus of any of clauses 22-26, wherein the means for implementing the selected signal suppression circuit reflection parameter value comprise means for implementing the selected signal suppression circuit reflection parameter value such that the selected signal suppression circuit reflection parameter value offsets, at least partially, the antenna reflection parameter.
Clause 28. The apparatus of clause 27, wherein the means for implementing the selected signal suppression circuit reflection parameter value comprise means for implementing the selected signal suppression circuit reflection parameter value such that the selected signal suppression circuit reflection parameter value offsets, at least partially, a combination of the antenna reflection parameter and a reference reflection parameter.
Clause 29. The apparatus of clause 28, further comprising means for determining the reference reflection parameter by:
routing, at a first time, the first portion of the transmit signal to a processor of the apparatus, the second portion of the transmit signal to a first load, and a load-reflected signal, corresponding to a reflection of the second portion of the transmit signal by the first load, to a second load;
routing, at a second time different from the first time, the first portion of the transmit signal to the second load, the second portion of the transmit signal to the first load, and the load-reflected signal to the processor; and
determining the reference reflection parameter based on a ratio of the first portion of the transmit signal at the first time and the load-reflected signal at the second time.
Clause 30. The apparatus of any of clauses 22-29, further comprising means for determining the plurality of possible signal suppression circuit reflection parameter values, wherein the means for determining the antenna reflection parameter and the means for determining the plurality of possible signal suppression circuit reflection parameter values are for determining the antenna reflection parameter and the plurality of possible signal suppression circuit reflection parameter values, respectively, based on test signals received at respective times from the same transmission line.
Clause 31. An apparatus comprising:
a signal source;
a power amplifier communicatively coupled to the signal source;
a transmit antenna;
transmit routing circuitry communicatively coupled to the power amplifier and the transmit antenna, and configured to selectively couple the power amplifier to the transmit antenna;
a processor; and
a signal suppression circuit communicatively coupled to the processor and comprising a plurality of reactive components at least one of which has a variable reactance selectable by the processor.
Clause 32. The apparatus of clause 31, wherein the signal suppression circuit comprises a double-pi circuit.
Clause 33. The apparatus of clause 32, wherein the double-pi circuit comprises a plurality of capacitors with a respective capacitor in each of three legs of the double-pi circuit and a plurality of inductances each communicatively coupled between a respective pair of the three legs of the double-pi circuit, wherein at least one of the plurality of capacitors is a variable capacitor.
Clause 34. The apparatus of clause 33, wherein each of the plurality of capacitors is a variable capacitor.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. Further, well-known circuits, processes, algorithms, structures, and/or techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20%, ±10%, ±5%, and ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20%, ±10%, ±5%, and ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method, for transmit signal leakage mitigation in an apparatus, comprising:
determining an antenna reflection parameter corresponding to a transmit antenna of the apparatus based on a first portion of a transmit signal and a reflected signal that corresponds to a reflection of a second portion of the transmit signal by the transmit antenna; and
implementing, based on the antenna reflection parameter, a selected signal suppression circuit reflection parameter value of a plurality of possible signal suppression circuit reflection parameter values.

2. The method of claim 1, wherein determining the antenna reflection parameter comprises determining the antenna reflection parameter intermittently over time.

3. The method of claim 2, further comprising, between consecutive determinations of the antenna reflection parameter:
routing the first portion of the transmit signal to a signal suppression circuit;
routing a third portion of the transmit signal corresponding to a reflection of the first portion of the transmit signal by the signal suppression circuit, to a processor of the apparatus; and
routing the reflected signal to the processor.

4. The method of claim 1, wherein determining the antenna reflection parameter comprises:
routing, at a first time, the first portion of the transmit signal to a processor of the apparatus;
routing, at a second time that is different from the first time, the reflected signal to the processor; and
determining the antenna reflection parameter based on a ratio of the first portion of the transmit signal at the first time and the reflected signal at the second time.

5. The method of claim 1, further comprising determining each of the plurality of possible signal suppression circuit reflection parameter values by, for each of a plurality of possible impedance values of a signal suppression circuit:
routing, at a first time, the first portion of the transmit signal to a processor of the apparatus;
routing, to the processor at a second time that is different from the first time, the first portion of the transmit signal to the signal suppression circuit and a third portion of the transmit signal corresponding to a reflection of the first portion of the transmit signal by the signal suppression circuit; and
determining a ratio of the first portion of the transmit signal at the first time and a combination of the third portion of the transmit signal and the reflected signal at the second time.

6. An apparatus comprising:
a power amplifier;
a transmit antenna;
a memory;
a signal suppression circuit having a plurality of possible signal suppression circuit reflection parameter values;
routing circuitry, communicatively coupled to the power amplifier, the transmit antenna, and the signal suppression circuit; and
a processor, communicatively coupled to the memory, the signal suppression circuit, and the routing circuitry, configured to:
determine an antenna reflection parameter based on a first portion of a transmit signal from the power amplifier and a reflected signal that corresponds to a reflection, by the transmit antenna, of a second portion of the transmit signal from the power amplifier; and
control, based on the antenna reflection parameter, the signal suppression circuit to implement a selected signal suppression circuit reflection parameter value of the plurality of possible signal suppression circuit reflection parameter values.

7. The apparatus of claim 6, wherein the processor is configured to determine the antenna reflection parameter intermittently over time.

8. The apparatus of claim 7, wherein the processor is configured to cause the routing circuitry, between consecutive determinations of the antenna reflection parameter, to:
route the first portion of the transmit signal to the signal suppression circuit;
route, to the processor, a third portion of the transmit signal corresponding to a reflection of the first portion of the transmit signal by the signal suppression circuit; and
route the reflected signal to the processor.

9. The apparatus of claim 6, wherein the routing circuitry comprises at least one coupler and a plurality of switches, and wherein the processor is configured to:
cause, at a first time, some of the plurality of switches, of the routing circuitry, to selectively communicatively couple the power amplifier to the processor via the at least one coupler to provide the first portion of the transmit signal to the processor;
cause, at a second time that is different from the first time, the plurality of switches to selectively communicatively couple the transmit antenna to the processor via the at least one coupler to provide the reflected signal to the processor; and
determine the antenna reflection parameter based on a ratio of the first portion of the transmit signal at the first time and the reflected signal at the second time.

10. The apparatus of claim 6, wherein the routing circuitry comprises at least one coupler and a plurality of switches, and wherein the processor is configured to determine each of the plurality of possible signal suppression circuit reflection parameter values by, for each of a plurality of possible impedance values of the signal suppression circuit:
causing, at a first time, some of the plurality of switches, of the routing circuitry, to selectively communicatively couple the power amplifier to the processor via the at least one coupler to provide the first portion of the transmit signal to the processor;
causing, at a second time that is different from the first time, the plurality of switches to: route the first portion of the transmit signal to the signal suppression circuit; and route, to the processor, a third portion of the transmit signal corresponding to a reflection of the first portion of the transmit signal by the signal suppression circuit; and
determining a ratio of the first portion of the transmit signal at the first time and a combination of the third portion of the transmit signal and the reflected signal at the second time.

11. The apparatus of claim 6, wherein the processor is configured to control the signal suppression circuit such that the selected signal suppression circuit reflection parameter value offsets, at least partially, the antenna reflection parameter.

12. The apparatus of claim 11, wherein the processor is configured to control the signal suppression circuit such that the selected signal suppression circuit reflection parameter value offsets, at least partially, a combination of the antenna reflection parameter and a reference reflection parameter.

13. The apparatus of claim 12, wherein the routing circuitry comprises at least one coupler and a plurality of switches, and wherein to determine the reference reflection parameter the processor is configured to:
cause, at a first time, the plurality of switches to: selectively communicatively couple the power amplifier to the processor via the at least one coupler to provide the first portion of the transmit signal to the processor; selectively communicatively couple the power amplifier to a first load to provide the second portion of the transmit signal to the first load; and selectively communicatively couple the first load to a second load via the at least one coupler to provide a load-reflected signal, corresponding to a reflection of the second portion of the transmit signal by the first load, to the second load;
cause, at a second time different from the first time, the plurality of switches to: selectively communicatively couple the power amplifier to the second load via the at least one coupler to provide the first portion of the transmit signal to the second load; selectively communicatively couple the power amplifier to the first load to provide the second portion of the transmit signal to the first load; and selectively communicatively couple the first load to the processor via the at least one coupler to provide the load-reflected signal to the processor; and
determine the reference reflection parameter based on a ratio of the first portion of the transmit signal at the first time and the load-reflected signal at the second time.

14. The apparatus of claim 6, wherein the routing circuitry is configured to provide test signals, at respective times, on the same transmission line to the processor for the processor to determine the antenna reflection parameter and to determine the plurality of possible signal suppression circuit reflection parameter values.

15. The apparatus of claim 6, wherein the signal suppression circuit comprises a double-pi circuit including a variable capacitor in each of three legs of the double-pi circuit and a plurality of inductances each communicatively coupled between a respective pair of the three legs of the double-pi circuit.

16. The apparatus of claim 6, wherein the apparatus is an RFID reader (Radio Frequency Identification reader).

17. An apparatus comprising:
a signal source;
a power amplifier communicatively coupled to the signal source;
a transmit antenna;
transmit routing circuitry communicatively coupled to the power amplifier and the transmit antenna, and configured to selectively couple the power amplifier to the transmit antenna;
a processor; and
a signal suppression circuit communicatively coupled to the processor and comprising a plurality of reactive components at least one of which has a variable reactance selectable by the processor.

18. The apparatus of claim 17, wherein the signal suppression circuit comprises a double-pi circuit.

19. The apparatus of claim 18, wherein the double-pi circuit comprises a plurality of capacitors with a respective capacitor in each of three legs of the double-pi circuit and a plurality of inductances each communicatively coupled between a respective pair of the three legs of the double-pi circuit, wherein at least one of the plurality of capacitors is a variable capacitor.

20. The apparatus of claim 19, wherein each of the plurality of capacitors is a variable capacitor.
